(19) United States
(12) Patent Application Publication
(10) Pub. No.: US 2008/0161526 A1
(43) Pub. Date: Jul. 3, 2008

(54) Cross-Linked Polyethylene Resin for Large Part Blow Molding

(75) Inventors: Gerhard Guenther, Kemah, TX (US); Lea Ann Nairn, League City, TX (US); Curtis D. Clark, League City, TX (US)

Correspondence Address: FINA TECHNOLOGY INC, PO BOX 674412, HOUSTON, TX, 77267-4412, US

(73) Assignee: FINA TECHNOLOGY, INC., Houston, TX (US)

(21) Appl. No.: 11/966,151

(22) Filed: Dec. 28, 2007

Related U.S. Application Data
(60) Provisional application No. 60/877,925, filed on Dec. 29, 2006.

(51) Int. Cl. C08F 110/02

(52) U.S. Cl. 526/352

(57) ABSTRACT

The invention relates generally to the production of polyethylene, and particularly to the production of polyethylene that is mixed with peroxides during extrusion to increase the level of long-chain branching. In an aspect, the polyethylene is used for large part blow molding (LPBM) applications. In an embodiment, the cross-linked polyethylene has a density of from about 0.945 g/cc to about 0.965 g/cc, a molecular weight distribution (MWD) of at least from 10 to 25, for example, and a high load melt index (HLMI) (ASTM D1238 21.6 kg) of from about 1 dg/min to about 30 dg/min. In an embodiment, the cross-linked polyethylene is comprised of at least one olefin having an ESCR of 100 hours to 1000 hours, and a flexural modulus of 120,000 psi to 250,000 psi.

### RELATED APPLICATIONS

This Application claims the benefit of U.S. Provisional Patent Application No. 60/877,925, filed Dec. 29, 2006.

### TECHNICAL FIELD

The invention relates generally to the production of polyethylene, and particularly to the production of polyethylene that is mixed with peroxides to increase the level of long-chain branching. In an aspect, the polyethylene is used for large part blow molding (LPBM) applications.

### BRIEF DESCRIPTION OF THE DRAWINGS

For a more complete understanding of the present disclosure and the advantages thereof, reference is now made to the following brief description, taken in connection with the accompanying drawings and detailed description, wherein like reference numerals represent like parts.

FIG. 1 is a plot of ESCR as a function of density and HLMI for samples of one embodiment of the invention.

FIG. 2 is a plot of Flexural Modulus as a function of density and HLMI for samples of one embodiment of the invention.

Figure are plots of Rheological Properties from samples containing different amounts of peroxides. additional HMA for the samples of Example 4.

### DETAILED DESCRIPTION

It has been found that improvements in the processability of polyethylene can be achieved by the addition or an increase in the level of long-chain branching of the polyethylene by adding a free radical initiator to the polyethylene before or during extrusion. The modified polyethylenes can be used in large part blow molding applications, for example.

The typical polyethylene resins that are used in large part blow molding (LPBM) are based on unimodal reactor technology (slurry loop and gas phase) utilizing chromium catalysts.

The polyethylenes that are especially useful in making large parts are bimodal in nature and can be obtained from Ziegler-Natta catalyzed polymerizations, and perhaps metallocene polymerizations and chromium catalyzed polymerizations.

As a result of the unique molecular architecture of bimodal resins relative to unimodal chromium resins, processing characteristics are significantly different. A key factor in producing a finished container with the best performance (good Environmental Stress Crack Resistance (ESCR), stiffness for stackability and cold impact resistance for drop testing) is that the container be made with an optimum wall distribution. LPBM processes/equipment are typically optimized to run unimodal chromium resins like Total Petrochemicals, USA, Inc. HDPE 54050 which have very specific swell, sag and elongational characteristics. The processing characteristics of bimodal ZN resins are significantly different from unimodal chrome resins and therefore can make it difficult with the current equipment (process conditions, tooling and mold design) to produce a container with optimal wall distribution and therefore make it difficult to capitalize on the resins bimodal resins superior properties.

Key performance needs from the resin in large part blow molding (LPBM) applications include resistance to chemicals (ESCR), stackability and lateral proximity of the articles (stiffness from density), and cold temperature drop impact resistance. While excellent processing and solid state properties of finished parts are achieved using these resins, bimodal resins utilizing Ziegler-Natta (ZN) catalyst technology, for example, allow for a step change improvement in the environmental stress crack resistance (ESCR) to stiffness compromise. This means that for a given density (which translates into stiffness), the ESCR of bimodal grades is higher than conventional unimodal grades. Conversely, for a given level of ESCR, a bimodal grade can be produced at a higher density thus translating into a stiffer finished container. The improvement is a consequence of the preferred comonomer incorporation of the bimodal grade, which can be biased such that more comonomer is incorporated in the high molecular weight (Mw) fraction of the resin. This advantage can then be translated into containers that require the use of less polyethylene (light-weighting) or containers with improved stacking performance.

Large part blow molding typically encompasses container sizes ranging from 5 gallons (20 liters) in the case of Jerrycans, 30 to 55 gallons in the case of drums and 275 (1040 liters) to 330 gallons (1250 liters) in the case of Industrial Bulk Containers (IBC), for example.

In order to minimize the processing differences of bimodal resins relative to unimodal chrome resins without a compromise in the inherent solid state properties of the bimodal resin, the rheological behavior of the bimodal resin can be modified by the addition of long chain branching (LCB) via a free radical initiator like peroxide (i.e., increasing shear response such that swell is increased, sag is reduced and elongational properties more closely match that of a typical LPBM unimodal grade).

The polyethylene of this invention can be a homopolymer or copolymer. The polymers (and blends thereof) formed via the processes described herein may include, but are not limited to, linear low density polyethylene, low density polyethylene, medium density polyethylenes, and high density polyethylenes. In an aspect, the ethylene polymer is a copolymer with an ethylene content of from about 90 to about 100 mol %, with the balance being made up of C₃-C₁₀ alpha olefins.

The Ziegler-Natta catalyzed polyethylene resins can be produced by the catalysts and polymerization methods, for example, disclosed in U.S. application Ser. No. 11/474,145 entitled “Formation of Ziegler-Natta Catalyst” by Kayo Vizzini et al., filed on Jun. 23, 2006, the contents of which are fully incorporated by reference herein. Other examples of other types of polyethylene resins that can be used for such applications include, by way of example those disclosed in U.S. patent application Ser. No. 11/732,617 to Guenther et al., filed Apr. 4, 2007, entitled “Improved Crosslinking Resins”, the contents of which are fully incorporated by reference herein.

To cross-link the starting polymers the majority of which are typically linear, a free radical initiator is added to the polyethylene resin. The peroxide, as used herein, is that which results in light cross linking or branching of the polyethylene molecules. The preferred free radical initiators are peroxides, particularly the organic peroxides. Several classes of organic peroxides have been found to be particularly suitable, such as the dialkyl and peroxyketal type peroxides. Other examples of a commercially available dialkyl peroxide suitable for use as a free radical initiator is 2,5-dimethyl-2,5-di(t-butylperoxy)hexane, available as LUPERSOL 101, and LUPERSOL 101PP20, a dialkyl peroxide from Arkema. Additionally, commercially available peroxyketal peroxides are LUPERSOL 233 and 533, which are examples of t-butyl and t-amyl type peroxides, respectively, and are also available from Arkema. Other peroxides or other free radical initiators known to one skilled in the art for cross-linking and/or chain branching can also be used.

The peroxide is usually added as a liquid, although the peroxide may be added in other forms as well, such as a peroxide coated solid delivery (i.e., masterbatch). The peroxide may also be added or combined with the polyethylene prior to or after the polyethylene is fed into the extruder. When the peroxide is added to the fluff prior to extrusion, the peroxide should be thoroughly mixed or dispersed throughout the polymer before being introduced into the extruder. Alternatively, the peroxide can be injected into the polyethylene melt within the extruder. The peroxide may be introduced into fluff stream or the extruder through any means known to those skilled in the art, such as by means of a gear pump or other delivery device. If oxygen or air is used as the initiator, these are preferably injected into the extruder within the polyethylene melt but may be introduced in the fluff upstream of the extruder. As disclosed in U.S. Pat. No. 6,433,103, to Guenther et al., the organic peroxide or other treating agent can be incorporated into the fluff prior to extrusion or injected into the polymer melt during the extrusion process.

The choice of peroxide may vary, however, depending upon the particular application and extruder temperatures encountered. Typical extruder temperatures are from about 350° F. to about 550° F. It is important that the extruder temperature or polyethylene melt be above the decomposition temperature of the peroxide. Thus, extruder temperatures will typically be at least 5% or higher than the decomposition temperature of the peroxide being used to ensure complete decomposition. The extruder temperature can be determined using a combination of peroxide half-life versus temperature data and the residence time in the extruder as prescribed by the desired throughput.

The amount of peroxide or initiator necessary to achieve the desired properties and processability may vary. The amount of peroxide or initiator is important, however, in that too little will not achieve the desired effect, while too much may result in undesirable products being produced. Typically, for peroxides, the amounts used are from about 5 to about 150 ppm, in another embodiment from about 10 to 100 ppm, and in a further embodiment from about 25 to about 75 ppm. Of course other additives known to one skilled in the art can be used during original production of the resin as well as during extrusion and may alter the amount of peroxide needed to achieve the desired effect.

In an embodiment phenolic and/or phosphate type antioxidants are added to the bimodal ethylene polymer before or after the peroxide addition to prevent degradation of the polymer. In another non-limiting embodiment of the invention, one or more antioxidants comprising a phosphite antioxidant and a phenolic antioxidant are used. Antioxidants and peroxides and/or air are used to balance or as a trade-off because they have opposite effects, and should generally be employed in pairs to maintain control of the resin characteristics and ultimate finish on the article. Increasing the peroxide proportion will increase LCB, while introducing an antioxidant improves the melt or thermal stability of the polymer.

In one nonlimiting embodiment of the invention, the antioxidant proportion ranges from about 300 to about 3,000 ppm by weight, based on the total resin. In an alternate nonlimiting embodiment, the antioxidant proportion may range from about 1000 to about 2000 ppm by weight, based on the total resin. In one non-Cross-Linked limiting embodiment of the invention, suitable antioxidants include, but are not necessarily limited to, phenolics and phosphites such as Irganox 1010 (phenolic antioxidant) and Irgafos 168 and Ultranox 627A (phosphite antioxidants), all available from Ciba-Geigy. In a further nonlimiting embodiment of the invention, one or more antioxidants are present in the article of manufacture in an amount ranging from about 400 ppm to about 1800 ppm.

For a further description of suitable treating agents which may be used in carrying out the invention and their matter of incorporation into the polymer product, reference is made to the aforementioned U.S. Pat. No. 6,433,103 to Guenther et al., the entire disclosure of which is incorporated herein by reference.

As set forth in the U.S. Pat. No. 6,433,103 to Guenther et al., entitled “Method of Producing Polyethylene Resins for Use in Blow Molding,” the long chain branching of a polymer can be characterized in terms of shear response or more specifically the ‘a’ parameter from a Carreau-Yasuda fit of a frequency sweep. Rheological breadth refers to the breadth of the transition region between Newtonian and power-law type shear rate dependence of viscosity. The rheological breadth is a function of the relaxation time distribution of the resin, which in turn is a function of the resin's molecular architecture. It is experimentally determined assuming Cox-Merz rule by fitting flow curves generated using linear-viscoelastic dynamic oscillatory frequency sweep experiments with a modified Carreau-Yasuda (CY) model,

η=η₀[¹⁺(λγ)^{a}]ⁿa^{−1}

wherein
η=viscosity (Pa s);
γ=shear rate (1/s);
a=rheological breadth parameter [CY model parameter which describes the breadth of the transition region between Newtonian and power law behavior];
λ=relaxation time in sec [CY model parameter which describes the location in time of the transition region]; and
η₀=zero shear viscosity (Pa s) [CY model parameter which defines the Newtonian plateau] n=power law constant [CY model parameter which defines the final slope of the high shear rate region].
   To facilitate model fitting, the power law constant (n) is held to a constant value (n=0). Experiments may be carried out using a parallel plate geometry and strains within the linear viscoelastic regime over a frequency range of 0.1 to 316.2 sec.sup.−1. Frequency sweeps can be performed at three temperatures (170° C., 200° C. and 230° C.) and the data then shifted to form a master curve at 190° C. using known time-temperature superposition methods.

For resins with no differences in levels of long chain branching (LCB), it has been observed that the rheological breadth parameter (a) is inversely proportional to the breadth of the molecular weight distribution. Similarly, for samples that have no differences in the molecular weight distribution, the breadth parameter (a) has been found to be inversely proportional to the level of long chain branching. An increase in the rheological breadth of a resin is therefore seen as a decrease in the breadth parameter (a) value for that resin. This correlation is a consequence of the changes in the relaxation time distribution accompanying those changes in molecular architecture.

Examples of the physical characteristics of the produced cross-linked resins are set forth herein. In an embodiment, the cross-linked polyethylene has a density of from about 0.945 g/cc to about 0.965 g/cc, or from about 0.950 g/cc to about 0.962 g/cc, or from about 0.952 g/cc to about 0.960 g/cc, for example. Also, such ethylene-based polymers may have a molecular weight distribution (MWD) of at least from 10 to 25, for example. The cross-linked ethylene polymers may have a high load melt index (HLMI) (ASTM D1238 21.6 kg) of from about 1 dg/min to about 30 dg/min., or from about 2 dg/min. to about 20 dg/min., or from about 3 dg/min. to about 10 dg/min, for example. In an embodiment, the cross-linked polymer has an ESCR of 100 hours to 1000 hours, and a flexural modulus of 120,000 psi to 250,000 psi.

The following ASTM tests were used to determine the physical characteristics of the polymers disclosed herein: density was measured under ASTM D792 guidelines; the Melt Flow Index was measured under ASTM D1238 (A) guidelines; flexural modulus (a calculation of stiffness) was measured using ASTM D790, and ESCR was measured using ASTM D1693, condition B 10% Igepal.

In an embodiment, a “large part” is defined herein to be an article that is a container and/or is of a size that will hold/could hold at least from 5 gallons (18.9 liters) up to 55 gallons (208.2 liters); in another embodiment, a large part is defined to be an article that is a container of a size that will hold/could hold at least from 55 gallons (208.2 liters) up to 275 gallons (1040 liters); in yet another embodiment, a large part is defined to be an article that is a container of a size that will hold/could hold at 275 gallons (1040 liters) up to 330 gallons (1250 liters).

Other examples of articles that can be manufactured from the cross-linked resins of this invention are, for example, disclosed in U.S. patent application Ser. No. 11/774,311 to Guenther et al., filed on Jul. 6, 2007, entitled Bimodal Blow Molding Resin And Products Made Therefrom, by Guenther et. al, which is fully incorporated by reference herein. Additionally, the articles produced by this polyethylene and method also include industrial parts, piping and tubular articles, industrial containers and drums, and consumer containers for a variety of uses including but not limited to agriculture chemicals, industrial chemicals, and food products.

In addition to the foregoing, the types of articles that can be made with the resins of this invention are virtually limitless and include those articles that are considered to be large parts and are made with at least 1 pound of resin to 150 pounds or more of resin. Further examples of the types of large part blow molded articles that can be made include, for example, table tops, basketball goal bases, stadium seats, plastic storage containers, boats, and watercraft.

### EXPERIMENTAL EXAMPLES

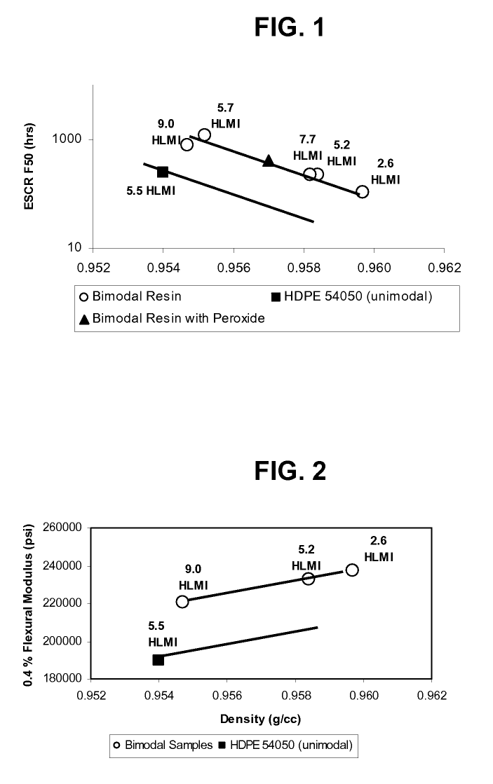

ESCR data for an embodiment of the PE resin of this invention is listed in Table 1 and shown in FIG. 1 for a conventional unimodal Chrome based LPBM grade (HDPE 54050) versus those of the invention.

TABLE 1
ESCR as a function of density and HLMI.

| | | Density | ESCR F50 (hrs) |
|---|---|---|---|
| | HLMI (dg/min) | (g/cc) | Cond B 10% Igepal |
| HDPE 54050 | 6.1 | 0.954 | 250 |
| Sample 1 | 5.2 | 0.958 | 221 |
| Sample 2 | 2.6 | 0.960 | 105 |
| Sample 3 | 7.7 | 0.958 | 224 |
| Sample 4 | 9.0 | 0.955 | 774 |
| Sample 5 | 5.7 | 0.955 | >1200 |
| Sample 6 | 7.5 | 0.957 | 400 |

Samples 1-5 are bimodal with no peroxide added while sample 6 is bimodal made with 50 ppm peroxide (Lupersol 101). While a strong relationship between density and ESCR exists (ESCR increases with a decrease in density), a shift in this relationship can be observed for the bimodal resin of this invention such that a 200% increase in the ESCR is seen at a density of 0.956 g/cc, for example.

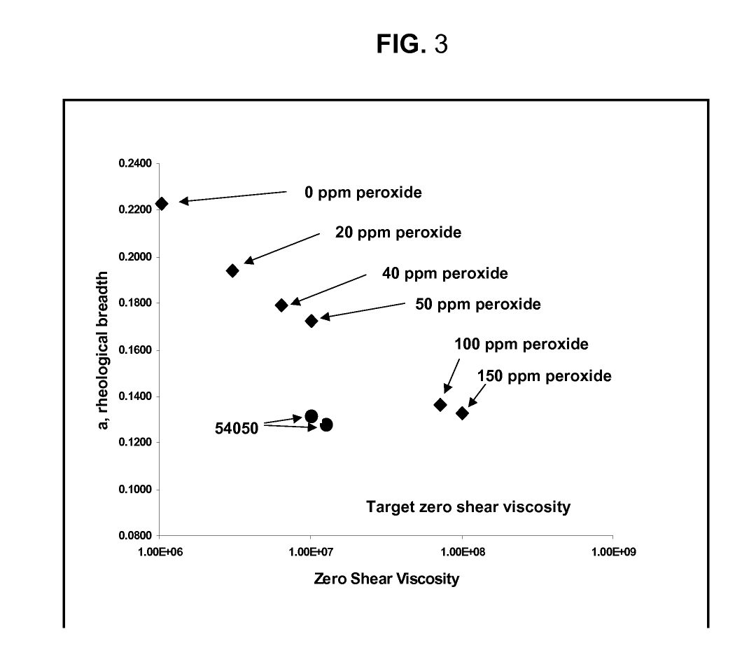

Similarly, in the case of resin stiffness as demonstrated in terms of the flexural modulus in Table 2 and FIG. 2, the resin density plays a large role, however at a given density (e.g., 0.956 g/cc) a step change increase in stiffness on the order of 20% is observed for the bimodal resin versus that of the conventional unimodal LPBM grade.

TABLE 2
Flexural Modulus as a function of density and HLMI.

| | | Density | 0.4% Strain Flex |
|---|---|---|---|
| | HLMI (dg/min) | (g/cc) | Mod (psi) |
| HDPE 54050 | 6.1 | 0.954 | 190,000 |
| Sample 1 | 5.2 | 0.958 | 232,800 |
| Sample 2 | 2.6 | 0.960 | 237,400 |
| Sample 3 | 7.7 | 0.958 | — |
| Sample 4 | 9.0 | 0.955 | 220,800 |
| Sample 5 | 5.7 | 0.955 | — |

Table 3 sets forth examples of polyethylene resin with various ppm of peroxide and the resulting zero shear viscosity and relaxation time therefore.

TABLE 3
Rheological Properties.

| | Zero Shear | | | |
|---|---|---|---|---|
| | Viscosity | Relaxation | | |
| Resin Details | (Pa s) | Time (s) | a | n |
| Bimodal Control (0 ppm peroxide) | 1.03E+06 | 0.9 | 0.223 | 0 |
| Bimodal (20 ppm peroxide) | 3.02E+06 | 2.2 | 0.194 | 0 |
| Bimodal (40 ppm peroxide) | 1.01E+07 | 5.5 | 0.172 | 0 |
| Bimodal (50 ppm peroxide) | 6.38E+06 | 4.0 | 0.179 | 0 |
| Bimodal (100 ppm peroxide) | 7.14E+07 | 33.8 | 0.136 | 0 |
| Bimodal (150 ppm peroxide) | 1.00E+08 | 50.0 | 0.133 | 0 |
| HDPE 54050 Sample 1 | 1.01E+07 | 1.6 | 0.131 | 0 |
| HDPE 54050 Sample 2 | 1.27E+07 | 1.9 | 0.128 | 0 |

FIG. 3 is related to Table 3. The target processing properties are achieved by more closely matching shear response or relaxation behavior and are defined in this case by the zero shear viscosity (or relaxation time) as achieved using frequency sweep viscosity data (see FIG. 3). As shown in FIG. 3, at equivalent HLMI values, bimodal resins (represented by the squares) have much lower zero shear viscosities than unimodal LPBM grades which in this case is illustrated using Total Petrochemicals USA, Inc. HDPE grade 54050 (represented by the circles). This characteristics translates into lower swell (less memory), more sag and lower elongational viscosity which effect the expansion and forming stage of the molding process. It is likely that an increase in LCB will offset the inherent Theological properties of the bimodal grade and make fit better with existing equipment (process conditions, tooling and mold designs).

While the invention has been shown in only some of its forms, it should be apparent to those skilled in the art that it is not so limited, but is susceptible to various changes and modifications without departing from the scope of the invention. Accordingly, it is appropriate that the appended claims be construed broadly and in a manner consistent with the scope of the invention.

We claim:

1. A method of forming an article with cross-linked polyethylene, comprising:
producing a bimodal polymer comprised of at least ethylene;
extruding the ethylene polymer and adding at least one peroxide during extrusion to cross-link the ethylene polymer;
forming an article; and
wherein the article made from the cross-linked bimodal ethylene polymer has an improved ESCR as compared to an article produced with a same ethylene polymer without an addition of the peroxide before or during extrusion.

2. The method of claim 1, wherein the article comprises a drum.

3. The method of claim 1, wherein the article comprises pipe or another tubular article.

4. The method of claim 1, wherein the cross-linking is characterized by an increase in shear response that results in improved melt strength due to a higher level of chain entanglements as shown by a higher zero shear viscosity as compared to the same ethylene polymer without the addition of the peroxide.

5. The method of claim 1, further comprised of adding an antioxidant to the bimodal ethylene polymer before or after the peroxide addition.

6. The method of claim 1, wherein the ethylene polymer comprises a copolymer.

7. The method of claim 1, wherein from 5 ppm to 150 ppm of the peroxide is added to the ethylene polymer.

8. The method of claim 1, wherein from 10 ppm to 100 ppm of the peroxide is added to the ethylene polymer.

9. The method of claim 1, wherein said cross-linked ethylene polymer has a molecular weight distribution (MWD) of from 10 to 25 for bimodal resins.

10. The method of claim 1, wherein said cross-linked ethylene polymer has an ESCR (condition B 10% Igepal) of from 100 hours to 1000 hours.

11. The method of claim 1, wherein said cross-linked ethylene polymer has a density of from 0.945 g/cc to 0.965 g/cc.

12. The method of claim 1, wherein said cross-linked ethylene polymer has a flexural modulus of 12,000 psi to 25,000 psi.

13. The method of claim 1, wherein said cross-linked ethylene polymer has a high load melt index (HLMI) of from 1 dg/min to 30 dg/min.

14. An article produced by the method of claim 1.

15. An article produced by the method of claim 1, wherein at least one pound to 150 pounds of polyethylene are used to produce said article.

16. The article of claim 14, wherein said article is selected from industrial parts, industrial containers, or consumer containers.

17. The article of claim 14, wherein said article is a container for agricultural chemicals, industrial chemicals, or food products.

18. The article of claim 14, wherein said article is a container of a size that will hold at least 5 gallons (18.9 liters) up to 55 gallons (208.2 liters).

19. The article of claim 14, wherein said article is a container of a size that will hold at least 55 gallons (208.2 liters) up to 400 gallons (1816 liters).

20. The article of claim 14, wherein said article is made from at least 1 pound of polyethylene resin up to 150 pounds of resin.
